(19) United States
(12) Patent Application Publication
(10) Pub. No.: US 2006/0001893 A1
(43) Pub. Date: Jan. 5, 2006

(54) Display device and image processing method therefor

(75) Inventor: Nai-Yueh Liang, Taipei City (TW)

Correspondence Address: BIRCH STEWART KOLASCH & BIRCH, PO BOX 747, FALLS CHURCH, VA, 22040-0747, US

(73) Assignee: Prodisc Technology Inc.

(21) Appl. No.: 10/983,752

(22) Filed: Nov. 9, 2004

(30) Foreign Application Priority Data
Jul. 5, 2004 (TW) 093120160

(51) Int. Cl. G06K 1/00

(52) U.S. Cl. 358/1.12

(57) ABSTRACT

A display device includes an image-gaining processing module, a first light source, a second light source, a modulating module, a first imager, a second imager and a combiner. The image-gaining processing module, which receives an image signal and filters out a first color image signal and a second color image signal, generates a first color gain value and a second color gain value, and generates a first color image-gaining signal and a second color image-gaining signal. The modulating module generates a first color control signal and a second color control signal. The first imager receives the first color image-gaining signal. The second imager receives the second color image-gaining signal. The combiner receives the first color image and the second color image to form an image.

### BACKGROUND OF THE INVENTION

1. Field of Invention

The invention relates to a display device and image processing method therefor and, in particular, to a display device and image processing method therefor with a large dynamic range.

2. Related Art

With the arrival of a multimedia era, the use of display devices, such as a CRT display, a LCD display, a plasma display, an electroluminescent display and a projection display, has become popular more and more in every field.

The image projecting systems can be divided into different types, such as CRT projector, LCD projector and DLP projector. The LCD projector and the DLP projector have come into widespread use because they are suitable for high luminance and high display quality.

However, the dynamic range of the LCD projector and the DLP projector is not large. For instance, the actual dynamic range of a LCD projector is about 300-400:1, and the actual dynamic range of a DLP projector is about 500-600:1 (here, a device has a large dynamic range means that it is able to display an image with high contrast and many-levels of gradation). If the dynamic range of a display device is not large enough, a user cannot differentiate images if the brightness of the images is darker (such as night images).

To solve this problem, U.S. Pat. No. 6,683,657 disclosed a projection display system 1, in which an illumination-light amount modulating means is provided to adjust the light amount illuminated to an optical modulator. As shown in FIG. 1, the light illuminated from a light source 11 is reflected by a reflector 12 and becomes a parallel light beam. After passing an integrator 13, the parallel light beam enters a PS converter 14, and is converted from a non-polarized light beam to a linearly-polarized light beam.

The linearly-polarized light beam then enters the optical device 15 having a rotatable polarizing plate. Afterwards the light beam illuminates to the LCD panel 18 via a plurality of reflection layers 16 and prisms 17. The LCD panel 18 controls the light beam to form an image. The polarizing plate is driven by a motor (not shown in the drawing). Since the polarizing plate rotates continuously, the amount of light entering the LCD panel 18 changes accordingly. The amount of light entering the LCD panel 18 is determined according to the input image signal, and the rotation angle of the polarizing plate, which correspondents to the rotation angle of the motor, is calculated in view of the amount of light.

However, the image projecting system mentioned above has an additional illumination-light amount modulating means, which makes the system heavier and larger, and thus not suitable for a compact projection system. Moreover, the angle of the polarizing plate is adjusted mechanically via a motor, which limits the precision of angle adjustment.

### SUMMARY OF THE INVENTION

In view of the above-mentioned problems, the invention is to provide a display device and an image processing method therefor with an increased dynamic range.

To achieve the above, in one embodiment of the invention, the display device includes an image-gaining processing module, a first light source, a second light source, a modulating module, a first imager, a second imager and a combiner. The image-gaining processing module, which receives an image signal and filters out a first color image signal and a second color image signal from the image signal, generates a first color gain value depend on the first color image signal and generates a second color gain value depend on the second color image signal, and generates a first color image-gaining signal according to the first color gain value and the first color image signal and generates a second color image-gaining signal according to the second color gain value and the second color image signal. The first light source emits a first color light beam. The second light source emits a second color light beam. The modulating module is electrically connected with the first light source, the second light source and the image-gaining processing module, wherein the modulating module generates a first color control signal according to the first color gain value to control the brightness of the light beam from the first light source to become a multiple of the original brightness of the light beam from the first light source and the inverse of the first color gain value, and generates a second color control signal according to the second color gain value to control the brightness of the light beam from the second light source to become a multiple of the original brightness of the light beam from the second light source and the inverse of the second color gain value. The first imager is electrically connected with the image-gaining processing module, wherein the first imager receives the first color image-gaining signal and produces a first color image using the controlled light beam from the first light source. The second imager is electrically connected with the image-gaining processing module, wherein the second imager receives the second color image-gaining signal and produces a second color image using the controlled light beam from the light source. The combiner receives the first color image and the second color image to form an image.

To achieve the above, in one embodiment of the invention, the image processing method for a display device comprises the steps of: receiving an image signal, filtering a first color image signal from the image signal, determining the maximum brightness of the first color image signal, dividing the maximum brightness of a first color imager by the maximum brightness of the first color image signal to obtain a first color gain value, multiplying the first color image signal by the first color gain value to obtain an first color image-gaining signal, generating a first color control signal according to the first color gain value to control the brightness of a first color light beam from a first light source to become a multiple of the original brightness of the first color light beam from the first light source and the inverse of the first color gain value, and sending the first color image-gaining signal to the first color imager and using the controlled light beam from the first light source to form a first color image.

From the above, the display device and the image processing method therefor according to the invention filters each different color image signal (for example, red color image signal, blue color image signal and green color image signal) from the input signal, obtains each color gain value using each different color image signal, multiplies each color image signal by each related color gain value, and adjusts the brightness of each color light source to become the multiple of the inverse of the related color gain value to enhance the dynamic range of both each color image signal and the display device. In addition, because each light beam is provide by each color light source and each color image signal is sent to each color imager, each color image signal may send to the corresponding color imager immediately, then using the combiner to form the image. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram of a display device in the prior art.

FIG. 2 is a schematic diagram of a display device according to the first embodiment of the invention.

FIG. 3 is a schematic diagram showing an example of calculating the image signal A_{G} and the image signal A_{G}′ in the first embodiment.

FIG. 4 is a schematic diagram of a digital processing projection device according to the first embodiment of the invention.

FIG. 5 is another schematic diagram of a first light source, a second light source and a third light source according to the first embodiment of the invention.

FIG. 6 is a flow diagram of an image processing method for a display device according to a second embodiment of the invention.

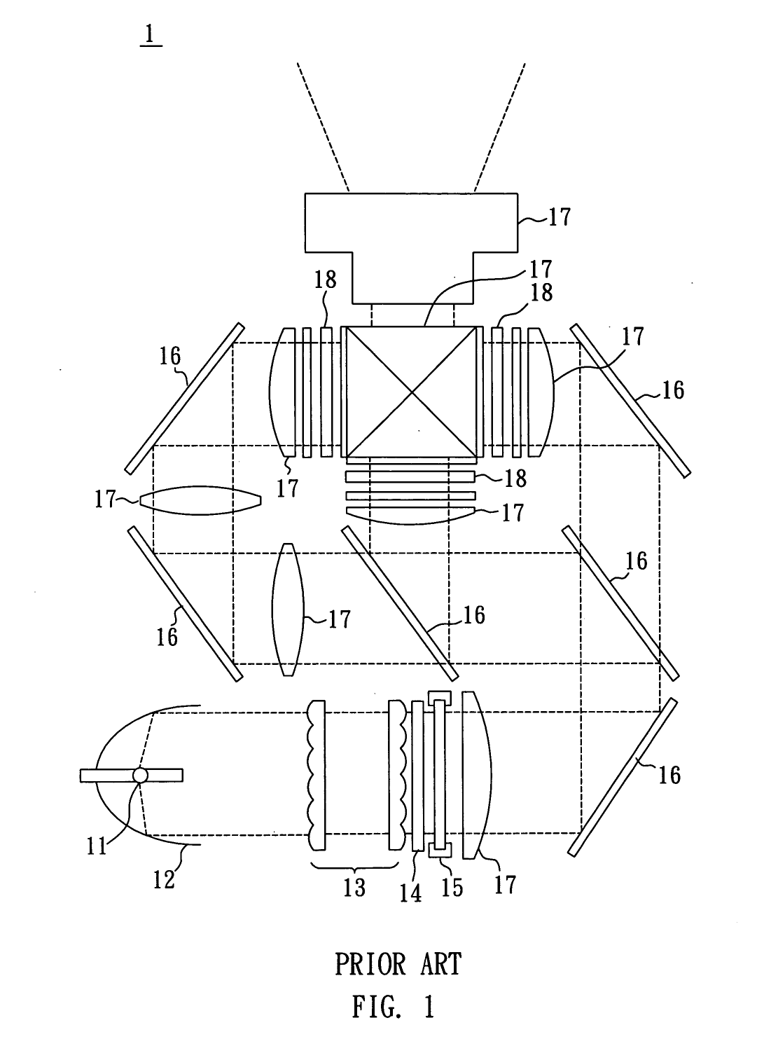

### DETAILED DESCRIPTION OF THE INVENTION

The display devices and the image processing method therefor according to the preferred embodiments of the invention will be described hereinbelow with reference to relevant drawings.

### First Embodiment

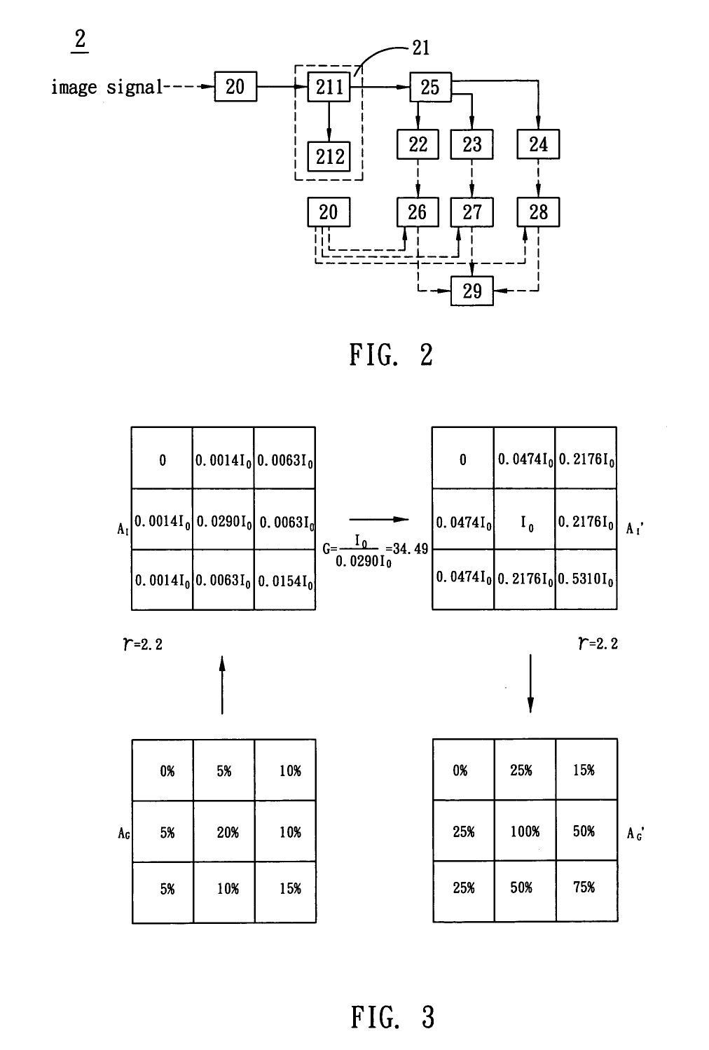

As shown in FIG. 2, the display device 2 according to the first embodiment of the invention includes an image-gaining processing module 21, a first light source 22, a second light source 23, a third light source 24, a modulating module 25, a first imager 26, a second imager 27, a third imager 28 and a combiner 29. The image-gaining processing module 21, which receives an image signal and filters out a first color image signal, a second color image signal and a third color image signal from the image signal. The image-gaining processing module 21generates a first color gain value (G1) depend on the first color image signal, generates a second color gain value (G2) depend on the second color image signal, and generates a third color gain value (G3) depend on the third color image signal. The image-gaining processing module 21 generates a first color image-gaining signal according to the first color gain value and the first color image signal, generates a second color image-gaining signal according to the second color gain value and the second color image signal, and generates a third color image-gaining signal according to the third color gain value and the third color image signal. The first light source 22 emits a first color light beam. The second light source 23 emits a second color light beam. The third light source 24 emits a third color light beam. The modulating module 25 is electrically connected with the first light source 22, the second light source 23, the third light source 24 and the image-gaining processing module 21, wherein the modulating module 25 generates a first color control signal according to the first color gain value to control the brightness of the light beam from the first light source 22 to become a multiple of the original brightness of the light beam from the first light source 22 and the inverse of the first color gain value, generates a second color control signal according to the second color gain value to control the brightness of the light beam from the second light source 23 to become a multiple of the original brightness of the light beam from the second light source 23 and the inverse of the second color gain value, and generates a third color control signal according to the third color gain value to control the brightness of the light beam from the third light source 24 to become a multiple of the original brightness of the light beam from the third light source 24 and the inverse of the third color gain value. The first imager 26 is electrically connected with the image-gaining processing module 21, wherein the first imager 26 receives the first color image-gaining signal and produces an first color image using the controlled light beam from the first light source 22. The second imager 27 is electrically connected with the image-gaining processing module 21, wherein the second imager 27 receives the second color image-gaining signal and produces an second color image using the controlled light beam from the second light source 23. The third imager 28 is electrically connected with the image-gaining processing module 21, wherein the third imager 28 receives the third color image-gaining signal and produces an third color image using the controlled light beam from the third light source 24. The combiner 29 receives the first color image, the second color image and the third color image to form an image.

In the present embodiment, the first color image signal, the second color image signal, and the third color image signal maybe a red image signal, a blue color image signal, and a green image signal.

In the present embodiment, the image-gaining processing module 21 includes an image gaining module 211 and an image processing module 212, the image gaining module 211 generates the first color gain value using the first color image signal, generates the second color gain value using the second color image signal, and generates the third color gain value using the third color image signal. The image-processing module 212 is electrically connected with the image-gaining module 211. The image processing module 212 generates the first color image-gaining signal according to the first color gain value and the first color image signal, generates the second color image-gaining signal according to the second color gain value and the second color image signal, and generates the third color image-gaining signal according to the third color gain value and the third color image signal.

Furthermore, the image gaining module 211 in the present embodiment generates the gain value using the image signal, which signal is provided by an image source (not shown in the drawing). The image source may be a digital image source or an analog image source. When the image source is an analog image source, the display device 2 may further include an AD converter to convert analog signals to digital signals.

In the present embodiment, the image gaining module 211 determines the maximum gray level of the first color image signal, and divides the maximum gray level of the imager 25 by the maximum gray level of the image signal to obtain the first color gain value. The image gaining module 211 determines the maximum gray level of the second color image signal, and divides the maximum gray level of the imager 25 by the maximum gray level of the image signal to obtain the second color gain value. The image gaining module 211 determines the maximum gray level of the third color image signal, and divides the maximum gray level of the imager 25 by the maximum gray level of the image signal to obtain the third color gain value. Alternatively, the image gaining module 211 may determine the maximum intensity of the first image signal, and divides the maximum intensity of the imager 15 by the maximum intensity of the first color image signal to obtain the first color gain value. The image gaining module 211 may determine the maximum intensity of the second image signal, and divides the maximum intensity of the imager 15 by the maximum intensity of the second color image signal to obtain the second color gain value. The image gaining module 211 may determine the maximum intensity of the third image signal, and divides the maximum intensity of the imager 15 by the maximum intensity of the third color image signal to obtain the third color gain value.

As shown in FIG. 2, the image processing module 212 is electrically connected with the image gaining module 211, and generates an image-gaining signal according to the gain value and the image signal. In other words, the image-gaining signal equals to the multiple of the gain value and the image signal. For example, the first color image-gaining signal equals to the multiple of the first color gain value and the first color image signal.

In the present embodiment, the first light source 22 emits the first color light beam for image production, the second light source 23 emits the second color light beam for image production, and the third light source 24 emits the third color light beam for image production. The first light source 22, the second light source 23 and the third light source 24 may be digital-controlled or analog-controlled light sources. For instance, the first light source 22, the second light source 23 and the third light source 24 may be light-emitting diodes (LED), light bulbs, laser (such as a semiconductor laser), organic LEDs, ultrahigh-press mercury lamps, metal halide lamps, xenon lamps or halogen lamps. Herein, as shown In FIG. 5, when the first light source 22, the second light source 23 and the third light source 24 are light emitting diodes, the first light source 22, the second light source 23 and the third light source 24 may combine to become a light emitting diode array. And, each color light beam from the first light source 22, the second light source 23 or the third light source 24 is guided to the corresponding imager (the first imager 26, the second imager 27 or the third imager 28) by fibers.

As shown in FIG. 2, the display device 2 according to the present embodiment may further include a gray level processing module 20. The gray level processing module 20 converts the image gray level signal into the image intensity signal, or converts the image intensity signal into the image gray level signal.

Furthermore, as shown in FIG. 2, the modulating module 25 is electrically connected with the first light source 22, the second light source 23, the third light source 24 and the image gaining module 211. The modulating module 25 generates a first color control signal to control the brightness of the first light source 22 according to the first color gain value, wherein the brightness comes out by multiplying the brightness of the original light by the inverse of the gain value. And, the modulating module 25 generates a second color control signal to control the brightness of the second light source 23 according to the second color gain value, wherein the brightness comes out by multiplying the brightness of the original light by the inverse of the gain value. And, the modulating module 25 generates a third color control signal to control the brightness of the third light source 24 according to the third color gain value, wherein the brightness comes out by multiplying the brightness of the original light by the inverse of the gain value. Here, the modulating module 25 may be a digital modulating module or an analog modulating module.

Moreover, the modulating module 25 may also control the open/close time of the first light source 22, so that the brightness of the light emitted by the first light source 22 becomes the multiple of the brightness of the original light and the inverse of the first color gain value. Alternatively, the modulating module 25 may also control the open/close time of the second light source 23, so that the brightness of the light emitted by the second light source 23 becomes the multiple of the brightness of the original light and the inverse of the second color gain value. Alternatively, the modulating module 25 may also control the open/close time of the third light source 24, so that the brightness of the light emitted by the second light source 24 becomes the multiple of the brightness of the original light and the inverse of the third color gain value.

The way of obtaining the first color gain value and the first color image-gaining signal will be described with reference to FIG. 3. First, the first color image gray level signal is converted to the first color image intensity signal. Then, the image gaining module 212 determines the maximum intensity of the first color image intensity signal, that is, 0.0290 I₀. Then, the maximum intensity of the imager 25 (I₀) is divided by the maximum intensity of the first color image intensity signal (0.0290 I₀) to obtain the first color gain value G1 (=34.49). Then, the image processing module 212 generates the first color image intensity-gaining signal according to the first color gain value G1 (=34.49) and the first color image intensity signal. Lastly, the first color image intensity-gaining signal is converted to the first color image gray level-gaining signal.

Of course, the way of obtaining the second (third) color gain value and the second (third) color image-gaining signal is same as the above.

As shown in FIG. 3 again, the gray level processing module 20 converts the first color image gray level signal to the first color image intensity signal by the following formula:
A₁=I₀×(A_{G})^{γ} (1)

wherein I₀ is the intensity value, A_{G} is the first color image gray level signal, A_{I} is the first color image intensity signal, and γ is an arbitrary number (for example, γ is 2.2 for a CRT display).

Please refer to FIG. 3 again, in the present embodiment, the gray level processing module 20 converts the first color image intensity-gaining signal to the first color image gray level-gaining signal using the following formula:
A_{G}′=(A_{I}′/I₀)^{1/γ} (2)
wherein I₀ is the intensity value, A_{G}′ is the first color image gray level-gaining signal, A_{I}′ is the first color image intensity-gaining signal and γ is an arbitrary number (for example, γ is 2.2 for a CRT display).

Of coerce, the gray level processing module 20 may convert the first color image gray level-gaining signal to the first color image intensity-gaining signal or converts the first color image intensity signal to the first color image gray level signal using the above formula (1) or (2).

Please refer to FIG. 2, the first imager 26 is electrically connected with the image-gaining processing module 21. The first imager 26 receives the first color image-gaining signal, and produces a first color image using the adjusted light beam from the first light source 22. The second imager 27 receives the second color image-gaining signal, and produces a second color image using the adjusted light beam from the second light source 23. The third imager 28 receives the third color image-gaining signal, and produces a third color image using the adjusted light beam from the third light source 24. The first color image, the second color image and the third color image form the image. This image substantially equals to the image signal.

In addition, the combiner 29 receives the first color image, the second color image and the third color image to form an image. The image substantially equals to the image signal.

In the present embodiment, the display device 2 includes, but not limited to, a DLP projector, a transparent type projector, a reflection type projector, or an LCD display.

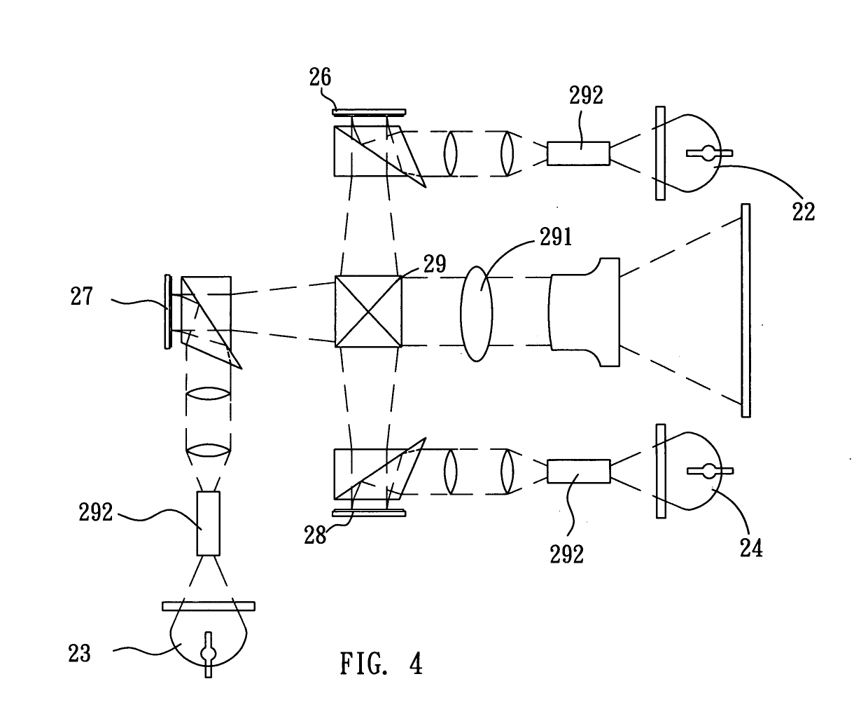

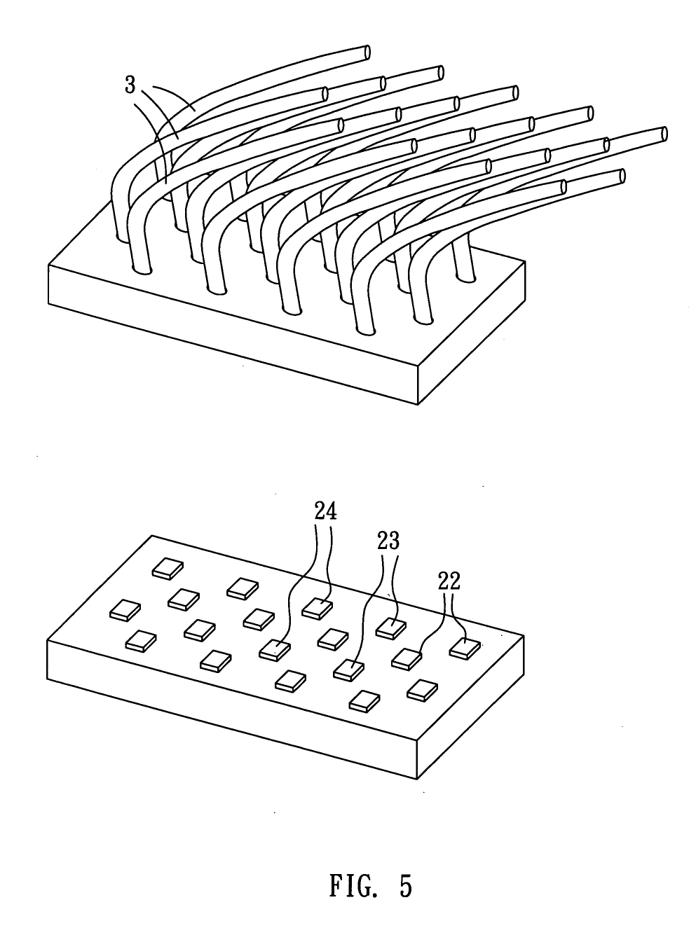

In the present embodiment, the first imager 26, the second imager 27 and the third image 28 respectively includes a display screen when the display device 2 is a projection display device. As shown in FIG. 4, when the display device 2 is a DLP projector, the first imager 26, the second imager 27 and the third image 28 respectively further includes a DMD (digital micro-mirror device). Furthermore, when the display device 2 is a transparent type LCD projector, the first imager 26, the second imager 27 and the third image 28 respectively further includes an LCD light valve. When the display device 2 is a reflection type LCD projector, the first imager 26, the second imager 27 and the third image 28 respectively further includes an LCD reflection panel. As shown in FIG. 5, certainly the display device 2 may be an LCD display, wherein the first imager 26, the second imager 27 and the third image 28 is respectively an LCD panel.

The display device 2 according to the present embodiment further includes a focus unit 291, as shown in FIG. 4. The focus unit 291 focuses the light beam emitted by the first light source 22, the second light source 23 or the third light source 24. Here, the focus unit 291 is provided on the light path.

The display device 2 according to the present embodiment further includes an optical guide 292, as shown in FIG. 4. The optical guide 292 is provided on the light path to make uniform the light emitted from the first light source 22 (or the second light source 23, the third light source 24). The optical guide 292 also has the function of light guiding or changing the direction of light.

### Second Embodiment

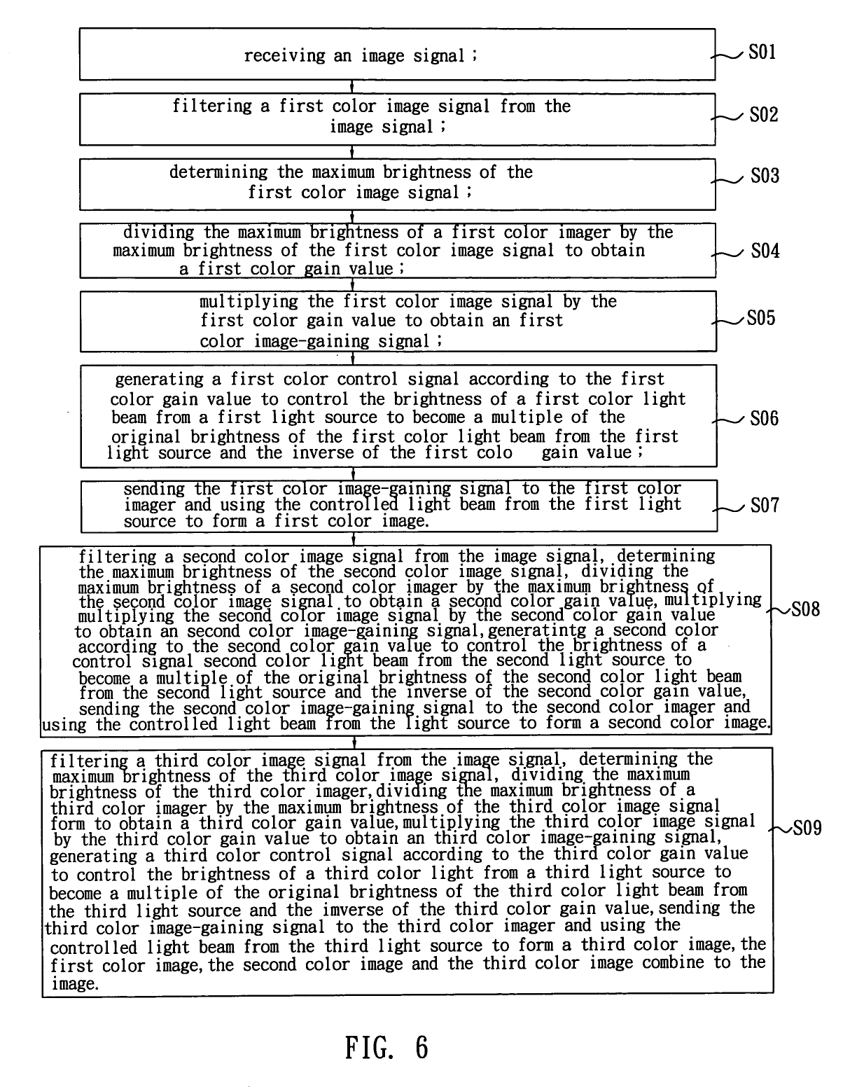

As shown in FIG. 6, the image processing method for a display device according to the second embodiment of the invention is receiving an image signal (SO 1), filtering a first color image signal from the image signal (S02), determining the maximum brightness of the first color image signal (S03), dividing the maximum brightness of a first color imager by the maximum brightness of the first color image signal to obtain a first color gain value (S04), multiplying the first color image signal by the first color gain value to obtain an first color image-gaining signal (S05), generating a first color control signal according to the first color gain value to control the brightness of a first color light beam from a first light source to become a multiple of the original brightness of the first color light beam from the first light source and the inverse of the first color gain value (S06), and sending the first color image-gaining signal to the first color imager and using the controlled light beam from the first light source to form a first color image (S07).

In addition, as shown in FIG. 5, the image processing method for a display device according to the present embodiment of the invention may further include the step of: filtering a second color image signal from the image signal, determining the maximum brightness of the second color image signal, dividing the maximum brightness of a second color imager by the maximum brightness of the second color image signal to obtain a second color gain value, multiplying the second color image signal by the second color gain value to obtain an second color image-gaining signal, generating a second color control signal according to the second color gain value to control the brightness of a second color light beam from the second light source to become a multiple of the original brightness of the second color light beam from the second light source and the inverse of the second color gain value, sending the second color image-gaining signal to the second color imager and using the controlled light beam from the second light source to form a second color image(S08).

In addition, as shown in FIG. 5, the image processing method for a display device according to the present embodiment of the invention may further include the step of: filtering a third color image signal from the image signal, determining the maximum brightness of the third color image signal, dividing the maximum brightness of a third color imager by the maximum brightness of the third color image signal to obtain a third color gain value, multiplying the third color image signal by the third color gain value to obtain an third color image-gaining signal, generating a third color control signal according to the third color gain value to control the brightness of a third color light from a third light source to become a multiple of the original brightness of the third color light beam from the third light source and the inverse of the third color gain value, sending the third color image-gaining signal to the third color imager and using the controlled light beam from the third light source to form a third color image, the first color image, the second color image and the third color image combine to the image (S09).

In step S01, receiving the image signal. Herein, the image signal can be represented by gray level or intensity.

In step S02, filtering the first color image signal (for example, red image signal) from the image signal.

In step S03, determining the maximum brightness of the first color image signal. Herein, the image signal is provided by an image source.

In step S04, dividing the maximum brightness of the imager by the maximum brightness of the first color image signal to obtain the first color gain value. Herein, the maximum brightness of the imager can be represented by gray level or intensity.

In step S05, multiplying the first color image signal by the first color gain value to obtain the first color image-gaining signal.

In step S06, generating the first color control signal according to the first color gain value to control the brightness of the first color light beam from the first light source to become the multiple of the original brightness of the first color light beam from the first light source and the inverse of the gain value. Herein, a modulating module same as the modulating module of the first embodiment may generate the control signal according to the first color gain value to control the brightness of the first color light from the first light source to become the multiple of the original brightness of the first color light beam from the first light source and the inverse of the first color gain value.

In step S07, sending the first color image-gaining signal to the first imager and using the controlled light beam from the first light source to form the first color image. In other words, an first imager same as the first imager of the first embodiment receives the first color image-gaining signal, and produces the first color image using the adjusted light beam from the first light source.

In addition, step S08 and step S09 repeats the step from step S01 to step S07, so the detailed descriptions are omitted here for concise purpose.

From step S01 to step S09, the first color image, the second color image and the third color image to form an image. The image substantially equals to the image signal.

From the above, the display device and the image processing method therefor according to the invention filters each different color image signal (for example, red color image signal, blue color image signal and green color image signal) from the input signal, obtains each color gain value using each different color image signal, multiplies each color image signal by each related color gain value, and adjusts the brightness of each color light source to become the multiple of the inverse of the related color gain value to enhance the dynamic range of both each color image signal and the display device. In addition, because each light beam is provide by each color light source and each color image signal is sent to each color imager, each color image signal may send to the corresponding color imager immediately, then using the combiner to form the image. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

The description should not be construed in a limiting sense. Any modifications and changes within the spirit and scope of the invention should be included in the appended claims.

What is claimed is:

1. A display device, comprising:
an image-gaining processing module, which receives an image signal and filters out a first color image signal and a second color image signal from the image signal, generates a first color gain value depend on the first color image signal and generates a second color gain value depend on the second color image signal, and generates a first color image-gaining signal according to the first color gain value and the first color image signal and generates a second color image-gaining signal according to the second color gain value and the second color image signal;
a first light source emitting a first color light beam;
a second light source emitting a second color light beam;
a modulating module electrically connected with the first light source, the second light source and the image-gaining processing module, wherein the modulating module generates a first color control signal according to the first color gain value to control the brightness of the light beam from the first light source to become a multiple of the original brightness of the light beam from the first light source and the inverse of the first color gain value, and generates a second color control signal according to the second color gain value to control the brightness of the light beam from the second light source to become a multiple of the original brightness of the light beam from the second light source and the inverse of the second color gain value;
a first imager electrically connected with the image-gaining processing module,
wherein the first imager receives the first color image-gaining signal and produces a first color image using the controlled light beam from the first light source;
a second imager electrically connected with the image-gaining processing module, wherein the second imager receives the second color image-gaining signal and produces an second color image using the controlled light beam from the second light source; and
a combiner receiving the first color image and the second color image to form an image.

2. The display device according to claim 1, wherein the image-gaining processing module includes an image gaining module and an image processing module, the image gaining module generates the first color gain value using the first color image signal, and generates the second color gain value using the second color image signal, the image processing module is electrically connected with the image gaining module, and generates the first color image-gaining signal according to the first color gain value and the first color image signal and generates the second color image-gaining signal according to the second color gain value and the second color image signal.

3. The display device according to claim 1, wherein the light source is a light-emitting diode (LED), a light bulb, a laser or an organic LED.

4. The display device according to claim 1, wherein the first color image-gaining signal equals to the first color gain value multiplied by the first color image signal, and the second color image-gaining signal equals to the second color gain value multiplied by the second color image signal.

5. The display device according to claim 1, wherein the image substantially equals to the image signal.

6. The display device according to claim 1, wherein the display device is of a projection type.

7. The display device according to claim 1, wherein the image-gaining processing module filters out a third color image signal from the image signal, and generates a third color gain value depend on the third color image signal, then generates a third color image-gaining signal according to the third color gain value and the third color image signal, the modulating module generates a third color control signal according to the third color gain value to control the brightness of a third color light beam from a third light source to become a multiple of the original brightness of the third color light beam from the third light source and the inverse of the third color gain value, the third light source is electrically connected with the modulating module, a third imager receives the third color image-gaining signal and produces a third color image using the controlled light beam from the third color light source, the combiner receives the first color image, the second color image and the third color image to form the image.

8. An image processing method for a display device, comprising the steps of:
receiving an image signal;
filtering a first color image signal from the image signal;
determining the maximum brightness of the first color image signal;
dividing the maximum brightness of a first color imager by the maximum brightness of the first color image signal to obtain a first color gain value;
multiplying the first color image signal by the first color gain value to obtain an first color image-gaining signal;
generating a first color control signal according to the first color gain value to control the brightness of a first color light beam from a first light source to become a multiple of the original brightness of the first color light beam from the first light source and the inverse of the first color gain value; and
sending the first color image-gaining signal to the first color imager and using the controlled light beam from the first light source to form a first color image.

9. The image processing method for a display device according to claim 8, further comprising the step of:
filtering a second color image signal from the image signal, determining the maximum brightness of the second color image signal, dividing the maximum brightness of a second color imager by the maximum brightness of the second color image signal to obtain a second color gain value, multiplying the second color image signal by the second color gain value to obtain an second color image-gaining signal, generating a second color control signal according to the second color gain value to control the brightness of a second color light beam from the second light source to become a multiple of the original brightness of the second color light beam from the second light source and the inverse of the second color gain value, sending the second color image-gaining signal to the second color imager and using the controlled light beam from the second light source to form a second color image.

10. The image processing method for a display device according to claim 9, further comprising the step of:
filtering a third color image signal from the image signal, determining the maximum brightness of the third color image signal, dividing the maximum brightness of a third color imager by the maximum brightness of the third color image signal to obtain a third color gain value, multiplying the third color image signal by the third color gain value to obtain an third color image-gaining signal, generating a third color control signal according to the third color gain value to control the brightness of a third color light from a third light source to become a multiple of the original brightness of the third color light beam from the third light source and the inverse of the third color gain value, sending the third color image-gaining signal to the third color imager and using the controlled light beam from the third light source to form a third color image, the first color image, the second color image and the third color image combine to the image.

11. The image processing method for a display device according to claim 8, wherein the image substantially equals to the image signal.

12. The image processing method for a display device according to claim 8, wherein the light source is a light-emitting diode (LED), a light bulb, a laser or an organic LED.

13. The image processing method for a display device according to claim 8, wherein the display device is of a projection type.

14. The image processing method for a display device according to claim 10, wherein a combiner receive the first color image, the second color image and the third color image to form the image.
